(19) United States
(12) Patent Application Publication
(10) Pub. No.: US 2008/0187072 A1
(43) Pub. Date: Aug. 7, 2008

(54) Method and Apparatus for Pulse Optimization for Hardware Implementation

(75) Inventors: Stephan V. Schell, San Mateo, CA (US); Paul Cheng-Po Liang, Santa Clara, CA (US)

Correspondence Address: PATENT LAW PROFESSIONALS, P.O. BOX 612407, SAN JOSE, CA, 95161, US

(73) Assignee: Matsushita Electric Industrial Co., Ltd.

(21) Appl. No.: 12/022,677

(22) Filed: Jan. 30, 2008

Related U.S. Application Data
(60) Provisional application No. 60/899,954, filed on Feb. 7, 2007.

(51) Int. Cl. H04L 25/03

(52) U.S. Cl. 375/296; 375/260

(57) ABSTRACT

Methods and apparatus for optimizing pulses provided by a pulse-shaping filter implemented in hardware. Pulses are optimized and generated by the pulse-shaping filter that are of finite length and meet one or more signal quality criteria, e.g., error vector magnitude (EVM) and/or adjacent channel leakage ratio (ACLR). According to one exemplary embodiment, a first finite length constraint is identified and a second out-of-band power criterion is identified. An error function is defined which measures the distortion of the generated signal relative to a reference pulse modeled after an ‘ideal’ pulse. The error function is minimized to determine optimized pulses, which when used to pulse-shape a communications signal, do not substantially increase in-channel distortion of said communications signal. To avoid the generation of excessive out-of-channel power, minimization is performed subject to a predetermined maximum allowable out-of-channel power condition.

### CROSS-REFERENCE TO RELATED APPLICATIONS

This patent application claims the benefit of U.S. Provisional Patent Application No. 60/899,954, filed on Feb. 7, 2007, the disclosure of which is hereby incorporated by reference.

### FIELD OF THE INVENTION

The present invention relates in general to communications systems. More specifically, the present invention relates to the conditioning of baseband modulated signals.

### BACKGROUND OF THE INVENTION

The radio spectrum is that part of the electromagnetic spectrum which is used by essentially all of today's telecommunications services. Because it is a highly regulated and limited resource, however, wireless service providers are faced with the challenge of increasing the amount of information that can be transmitted in given portions of the spectrum. This challenge of increasing what is often referred to as “spectral efficiency” is a difficult endeavor, which has become even more difficult in recent years due to the exploding demand for wireless communications services.

One way in which spectral efficiency can be increased in a telecommunications system is to increase the modulation complexity of information transmitted by transmitters in the system. For example, in a system using quadrature amplitude modulation (QAM), higher order constellations such as 16-QAM can be used to increase spectral efficiency, rather than using lower order QAM constellations such as 4-QAM (also known as binary phase shift keying (BPSK)). Increased spectral efficiency can be achieved using a higher order constellation since an increased number of bits of information can be transmitted per each symbol mapped into the constellation.

The importance of achieving high spectral efficiency can be seen by the manner in which successive generations of wireless standards bodies, such as the Third Generation Partnership Project (3GPP), have adopted more complex modulation schemes. For example, the evolution from GSM (Global System for Mobile Communications) to EDGE (Enhanced Data Rates for GSM Evolution) to UMTS (Universal Mobile Telecommunications System) has introduced progressively more complex modulation schemes, from 0.3-GMSK to 3π/8-shifted 8-PSK to HPSK, respectively. Each of these modulation schemes provides an increased level of spectral efficiency.

Although increasing the modulation complexity can help to increase spectral efficiency, modulation schemes are typically specified and fixed by standards and, therefore, cannot be altered without violating the standard's specifications. For this reason, alternative ways to increase spectral efficiency have been sought.

Another approach to increasing spectral efficiency is to increase the number of communications channels that can be accommodated within a given portion of the radio spectrum. FIGS. 1A and 1B are simplified power spectral density curves that illustrate this principle. In FIG. 1A, a first channel 102 has a center frequency of f₀ and a second, adjacent channel 104 has a center frequency of f₁. Because the spectral roll-off is gradual, the two channels overlap and interfere with each other, even though a guard band is employed to lessen the effects of the interference. By contrast, the more steeply-sloped spectral roll-off for adjacent channels 106 and 108 in FIG. 1B results in no spectral overlap between the two channels, and there is no adjacent channel interference. Hence, it can be seen that high spectral roll-off increases spectral efficiency by allowing communication channels to be assigned closer to one another. High spectral roll-off also allows the guard-bands between channels to be reduced, thereby further increasing spectral efficiency.

The steepness of spectral roll-off is quantified by a roll-off factor, which is typically referred to in the art as “the βfactor.” In other words, the spectral roll-off of a pulse-shaped signal is determined by the roll-off factor of the pulse-shaping filter used to create the signal. FIG. 2 is a diagram illustrating how a pulse-shaping filter is typically configured in a baseband portion of a telecommunications transmitter. Input binary sequences of digital bits are grouped into symbols according to the modulation scheme being employed and mapped into a constellation. For example, in the exemplary process shown in FIG. 2, quadrature phase shift keying QPSK is used to map an input digital sequence of binary bits 202 to a signal constellation 204. An impulse train 206 is then generated according to signal points in the constellation 204. Finally, the impulse train 206 is passed through a pulse-shaping filter 208 having an impulse response p_{T}(t), to generate a continuous signal waveform 210 that is encoded with information contained in the original digital sequence of binary bits 202.

Unlike the modulation scheme, the pulse-shaping filter is not typically fixed by wireless standards. Rather, characteristics of the pulse-shaping filter are most of the time only suggested. This affords manufacturers the ability to design their own pulse-shaping filters to satisfy their own implementation requirements, while at the same time complying with the applicable wireless standard.

The suggested pulse-shaping filter for third generation (3G) UMTS (Universal Mobile Telecommunications System) applications is the root-raised cosine (RRC) pulse-shaping filter. The RRC pulse-shaping filter is widely used, not just in 3G systems, which are currently being deployed throughout the World, but also in earlier and existing systems such as, for example, the IS-95 (also known as TIA-EIA-95) and IS-2000 (also known as CDMA2000) systems. The wide acceptance of the RRC pulse-shaping filter can be attributed to the fact that it has zero inter-symbol interference (ISI) and an adjustable spectral roll-off.

The RRC filter frequency response can be expressed mathematically as follows:

$${p}_{rrc} ( f ) = \{ \begin{matrix}\sqrt{T} & 0 \leq \vert f \vert < \frac{1 - β}{2 T} \\ \sqrt{\frac{T}{2} \{ 1 + cos [ \frac{π T}{β} ( \vert f \vert - \frac{1 - β}{2 T} ) ] \}} & \frac{1 - β}{2 T} \leq \vert f \vert < \frac{1 + β}{2 T} \\ 0 & \vert f \vert > \frac{1 + β}{2 T}\end{matrix}$$

where β is the roll-off factor and occupies a range of 0≦β≦1. The impulse response of the RRC pulse-shaping filter can be expressed in the time domain as:

$${p}_{rrc} ( t ) = \frac{1 - β}{T} sin c ( \frac{π t}{T} ( 1 - β ) ) + \frac{β}{T} sin c ( \frac{π β t}{T} + \frac{π}{4} ) cos ( \frac{π t}{T} + \frac{π}{4} ) + \frac{β}{T} sin c ( \frac{π β t}{T} - \frac{π}{4} ) cos ( \frac{π t}{T} - \frac{π}{4} )$$

From the time and frequency domain expressions of the RRC filter above, it can be seen that the length of the time impulse response is infinite. Unfortunately, from an implementation perspective, designing a filter having an infinite time impulse response is not practical.

One approach that has been used to avoid the infinite time impulse response of an RRC filter is to apply a “windowing” mechanism, which has the effect of accelerating the signal roll-off and reducing the time span of the pulse. Unfortunately, this windowing process does not provide any means for preserving the modulation accuracy of the signal generated by the modulator and, therefore, does not account for distortion being introduced into the signal. Distortion can hinder the ability of the transmitter to generate signals that can be reliably detected at the receiving end of the communications system. What is needed, therefore, are methods and apparatus for improving spectral efficiency while maintaining good modulation accuracy and without unduly introducing distortion into the modulated signal.

### SUMMARY OF THE INVENTION

Methods and apparatus for optimizing pulses used for pulse-shaping implementation in hardware are disclosed. Pulses are optimized such that the resultant pulse is of finite length and meets certain signal quality criteria, e.g., error vector magnitude (EVM) and adjacent channel leakage ratio (ACLR).

According to one exemplary embodiment, a first finite length constraint is identified and a second out-of-band power criterion is identified. An error function is then defined which measures the distortion of the generated signal relative to an ideal reference pulse. The error function is minimized to determine optimized pulses, which when used to pulse-shape a modulated communications signal, do not substantially contribute to an increased level of in-channel distortion of the communications signal. To avoid the generation of excessive out-of-channel power, minimization may also be performed subject to a predetermined maximum allowable out-of-channel power condition.

### BRIEF DESCRIPTION OF THE DRAWINGS

The present invention may be further understood from the following detailed description in conjunction with the appended drawings.

FIG. 1A is a simplified frequency domain plot showing an example of a signal having a slow spectral roll-off;

FIG. 1B is a simplified frequency domain plot showing an example of a signal having a more steeply sloped spectral roll-off than the signal in FIG. 1A;

FIG. 2 is a diagram of a baseband modulation process, including how a pulse-shaping filter is typically configured within the process;

FIG. 3 is a block diagram of a pulse optimizing modulator apparatus, according to an embodiment of the present invention;

FIG. 4 is a block diagram illustrating how the optimized pulse rₒₚₜ(t) generated by the pulse optimizer of the pulse optimizing apparatus in FIG. 3 can be used in a communications transmitter, according to an embodiment of the present invention;

FIG. 5 is a simplified block diagram of the baseband portion of a communications receiver illustrating how a communications signal is passed through a matched filter and sampled to extract information from the signal;

FIG. 6 is a flow chart highlighting salient steps involved in generating an optimized pulse rₒₚₜ(t), in accordance with an embodiment of the present invention;

FIG. 7 is a table showing performance measures of various optimized pulses, a reference filter, and the performance requirements defined by the UMTS specification;

FIG. 8A is a plot of the time impulse response of a reference pulse;

FIG. 8B is a plot of a design pulse; and

FIG. 9 is a plot comparing the frequency responses of a reference pulse-shaping filter and an optimized pulse-shaping filter.

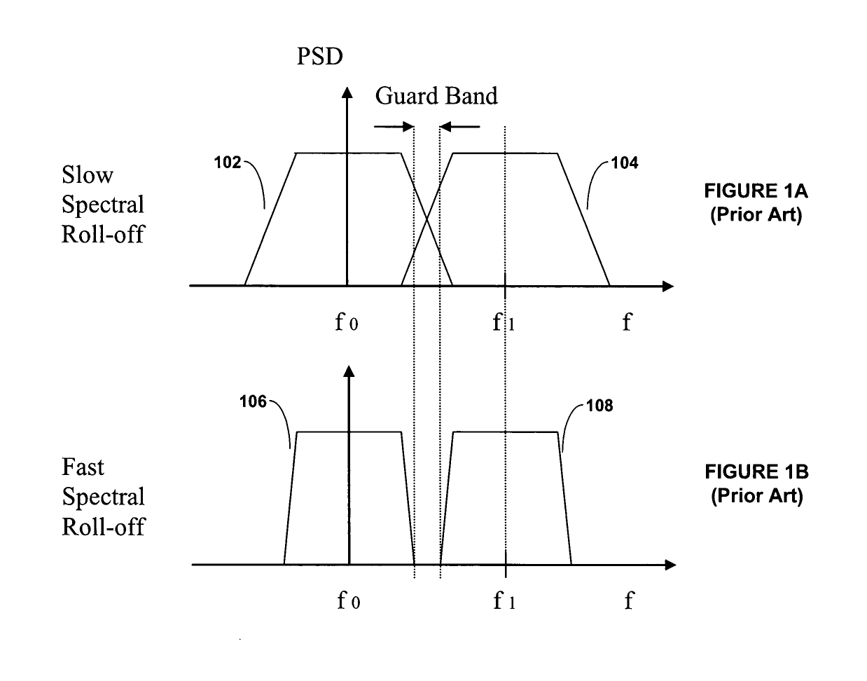

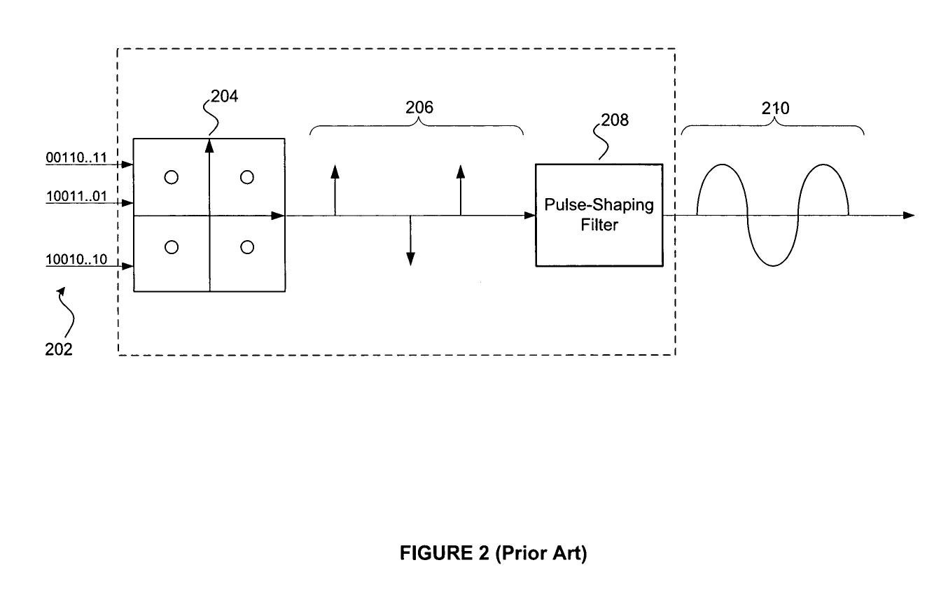

### DETAILED DESCRIPTION

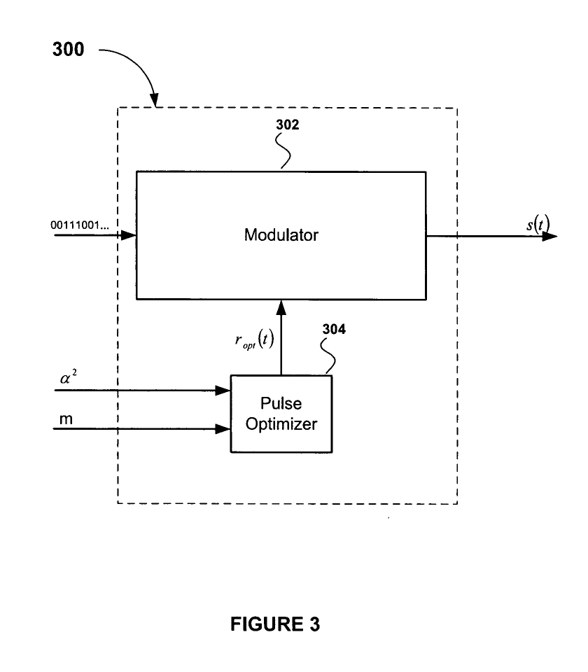

Referring first to FIG. 3, there is shown a block diagram of a pulse optimizing modulator apparatus 300, according to an embodiment of the present invention. The pulse optimizing modulator apparatus 300 comprises a modulator 302 and a pulse optimizer 304. The modulator 302 is configured to receive a digital message and generate a signal s(t), which is subsequently frequency up-converted and radiated by an antenna. As explained in detail below, the pulse optimizer 304 is configured to receive energy parameters α² characterizing a predetermined adjacent channel leakage ratio (ACLR) and a finite pulse-length parameter m to compute an optimized pulse rₒₚₜ(t) The optimized pulse rₒₚₜ(t) is used by a pulse-shaping filter of the modulator 302 to generate the signal s(t).

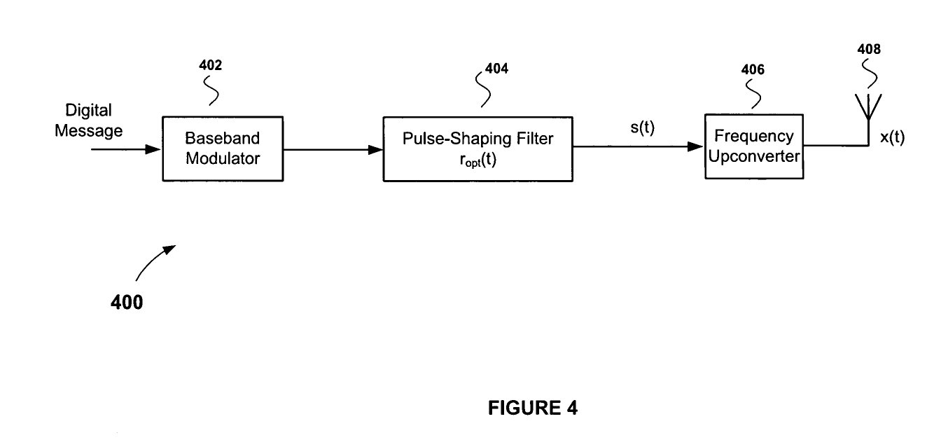

FIG. 4 is a block diagram illustrating how the optimized pulse rₒₚₜ(t) generated by the pulse optimizer 304 in FIG. 3 can be used in a communications transmitter 400, according to an embodiment of the present invention. The digital transmitter 400 includes a signal path having a baseband modulator 402, a pulse-shaping filter 404, a frequency upconverter 406, and an antenna 408. The baseband modulator 402 is adapted to receive a digital message and generate a stream of digital symbols in the form of a series of weighted impulses d(t). The series of weighted impulses (or “impulse train”) can be expressed mathematically as:

$$d ( t ) = {\sum }_{n = - ∞}^{∞} {b}_{n} δ ( t - nT ) ,$$

where bₙ is a weighting factor based on the constellation point at time n, δ(t) is the unit impulse function, and T represents the symbol period.

The pulse-shaping filter 404, which has an impulse response rₒₚₜ(t), is configured to receive the impulse train d(t) and generate a pulse-shaped (i.e., pulse optimized) signal:

$$s ( t ) = {\sum }_{n = - ∞}^{∞} {b}_{n} {r}_{opt} ( t - nT ) .$$

The pulse optimized signal s(t) is coupled to the frequency up-converter 406, which upconverts the optimized signal s(t) to an RF signal x(t). The antenna 408 then radiates the modulated RF signal x(t) to a receiver. The upconversion process can be described mathematically as follows:

x(t)=Re{g·s(t)e^{jW}^{_{c}}^{t}},

where g represents the amplifier gain, w_{c} represents the carrier frequency in radians per second, j represents the square-root of negative unity, and Re{.} denotes the real part of the upconverted, pulse-shaped signal.

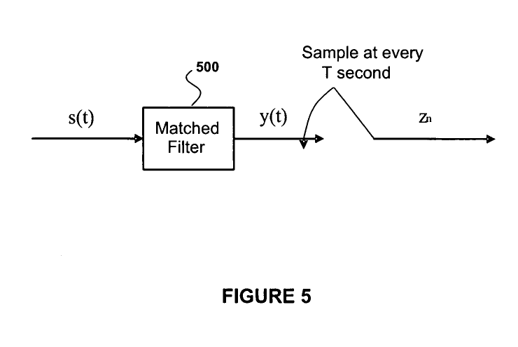

At the receiving end of the communications system, the RF signal x(t) is downconverted, and as shown in FIG. 5, passed through a matched filter 500 and sampled to recover the digital information. The signal y(t) at the output of the matched filter 500 can be expressed as:

y(t)=∫_{-∞}²⁸s(t+τ)r_{opt,R}(−τ)dτ.

According to this example, the matched filter 500 comprises the RRC filter recommended by the wireless standards.

The output of the matched filter, which in this example is sampled at every T second, can be expressed as:

$${z}_{n} = y ( nT ) = {b}_{n} {\int }_{- ∞}^{∞} {r}_{opt , T} ( τ ) {r}_{opt , R} ( - τ ) d τ + {\sum }_{i \neq n , i = - ∞}^{∞} {b}_{i} {\int }_{- ∞}^{∞} {r}_{opt , T} ( τ + nT - iT ) {r}_{opt , R} ( - τ ) d τ ,$$

where zₙ is the sampled output at time instance nT. For simplicity, it has been assumed in this exemplary embodiment that the sampling instants for detection occur at integer multiples of T. Those of ordinary skill in the art will readily appreciate and understand, however, that other sampling instants could alternatively be used.

As discussed above, the RRC pulse-shaping filter is widely used in 2G and 3G communications systems due to its zero inter-symbol interference (ISI) property and because it has an adjustable spectral roll-off. However, because it has an infinite time impulse response, in practice it cannot be easily implemented in hardware. To overcome this problem, and according to an embodiment of the invention, an optimized pulse, such as rₒₚₜ(t) discussed above, is designed to approximate a reference pulse. Below, an exemplary method of designing a pulse-optimizing filter capable of providing such an optimized pulse is disclosed. A primary goal of the design is to reduce the time duration of the approximated pulse while maximizing the modulation accuracy (i.e., maximizing in-band signal quality) for a given level of adjacent channel interference. Since these in-channel and out-of-channel signal characteristics are considered in the design, they will be discussed first.

In general, signal quality can be grouped into two general categories: in-channel signal quality and out-of-channel signal quality. The conventional in-channel measure of signal quality is the RMS error vector magnitude (EVM). A mathematically related measure is rho, which is the normalized cross-correlation coefficient between the transmitted signal and its ideal version. EVM and rho describe the ease by which a receiver can extract a digital message from an RF signal transmitted. As EVM increases, the transmitted signal becomes increasingly distorted compared to a desired signal. This distortion increases the likelihood that the receiver will make errors while extracting the message.

EVM is commonly expressed mathematically as the root-mean-square (RMS) EVM. For example, the RMS EVM in the 3GPP UMTS specification is measured at the sampled output after the matched filter and is expressed as:

$$RM S EVM = \frac{\sqrt{\frac{1}{2560} {\sum }_{n = 1}^{2560} {\vert {z}_{n , measure} - {z}_{n , ideal} \vert}^{2}}}{\sqrt{\frac{1}{2560} {\sum }_{n = 1}^{2560} \vert {z}_{n , ideal}^{2} \vert}} ,$$

where Z_{n,measure} and Z_{n,ideal} are the samples of the measured and ideal waveform at the output of the matched filter. (The number “2560” is derived from the number of chips per power control group.) As can be seen, the UMTS RMS EVM is expressed as a ratio of the mean error vector power to the mean reference signal power. Typically, the RMS EVM is expressed as a percentage, and in the UMTS specification EVM performance is limited to 17.5%.

Out-of-channel signal quality, which characterizes the degree to which a desired signal interferes with other adjacent channels, is often characterized by what is known as the adjacent channel leakage ratio (ACLR). It is usually measured at the output of the matched filter of the receiver but before sampling. The 3GPP UMTS specification defines ACLR as the ratio of the power measured in an adjacent channel to the transmitted power. For example, assume that the desired channel and an undesired adjacent channel have a frequency separation of f_{adj}. The signal output y₀(t) at the desired channel and the signal output y₁(t) at the adjacent channel can then be expressed as:

y₀(t)=∫_{-∞}^{∞}s(t+τ)r_{opt,R}(−τ)dτ

and

y₁(t)=∫_{-∞}^{∞}s(t+τ)r_{opt,R}(−τ)e^{-j2πf}^{_{adj}}^{τ}dτ.

With these expressions of in-channel and adjacent channel signal outputs, the ACLR can be expressed as follows:

$$ACLR ( dB ) = 10 * log 10 ( \frac{\int {y}_{0}^{2} ( t ) d t}{\int {y}_{1}^{2} ( t ) d t} )$$

In the UMTS specification, both the transmitted power and the adjacent channel power are measured with a RRC filter with roll-off of β=0.22 and a bandwidth equal to the chip rate. On the user equipment (UE) side, the ACLR for the power classes of 3 and 4 (24 and 21 dBm) have been set to −33 dB and −43 dB for ACLR and alternate ACLR, respectively.

Considering the expressions for RMS EVM and ACLR above, a pulse-shaping filter that provides an optimized pulse rₒₚₜ(t) while preserving signal quality and bounding hardware implementation complexity is disclosed. First, a reference pulse is selected. The reference pulse should have the effect of introducing as little in-band distortion into the signal as possible. According to an aspect of the invention, a reference filter based on an ‘ideal’ pulse-shaping filter (e.g., an RRC pulse-shaping filter) is selected. The need to select a reference filter follows from the fact that the ‘ideal’ pulse-shaping filter has an infinite impulse response. Second, the signal duration of the design pulse has to be designed. The length of the design pulse is made shorter than the reference pulse, so that the resulting design pulse can be successfully implemented in hardware.

Now that the optimization criteria for the design pulse have been identified and defined, a minimization problem can be formulated to minimize the RMS EVM. The reference waveform generated from the reference filter r_{ref}(t) and the designed waveform generated from the design filter r_{des}(t) can be expressed as:

$${s}_{ref} ( t ) = {\sum }_{n = - ∞}^{∞} {b}_{n} {r}_{ref} ( t - nT )$$

$$and$$

$${s}_{des} ( t ) = {\sum }_{n = - ∞}^{∞} {b}_{n} {r}_{des} ( t - nT ) ,$$

where r_{ref}(t) and r_{des}(t) are the pulse-shaping filters used for generating the reference waveform and design waveform, respectively.

The design criterion is to minimize RMS EVM. However, minimizing RMS EVM is equivalent to minimizing MS EVM. MS EVM can be expressed as:

$$\begin{matrix}MS EVM = R MS {EVM}^{2} \\ = \frac{{\sum }_{k} {\vert {s}_{des} ( t ) ⊗ {r}_{ref} ( - t ) {\vert}_{t = kT} - {s}_{ref} ( t ) ⊗ {r}_{ref} ( - t ) {\vert}_{t = kT} \vert}^{2}}{{\sum }_{k} {\vert {s}_{ref} ( t ) ⊗ {r}_{ref} ( - t ) \vert}_{t = kT}} ,\end{matrix}$$

where \textcircled{×} denotes convolution. According to an exemplary embodiment of the invention, the receiver filter has the same properties of the transmitter filter. Given this property, and with zero-mean uncorrelated symbols or chips {bₙ}, it can be shown that the MS EVM is equivalent to:

$$MS EVM = \frac{{\sum }_{k} {\vert {s}_{des} ( t ) ⊗ {r}_{ref} ( - t ) {\vert}_{t = kT} - {s}_{ref} ( t ) ⊗ {r}_{ref} ( - t ) {\vert}_{t = kT} \vert}^{2}}{{\sum }_{k} {\vert {s}_{ref} ( t ) ⊗ {r}_{ref} ( - t ) \vert}_{t = kT}}$$

The design objective is to minimize MS EVM with respect to r_{des}(t). Minimization of the above equation can be simplified by minimizing the EVM of a single pulse, which is the design pulse. Although the definition of EVM is different from the EVM definition specified by the UMTS standard, minimization of the EVM for a single pulse will apply to the minimization of the EVM for an entire time slot as specified by the specification. The minimization problem can be further simplified by recognizing that the denominator of the MS EVM equation above is independent of r_{des}(t). Because it is, the denominator can be dropped from the optimization process. Taking these simplifications into account, the following cost function can be formulated, which is the sum of squared errors (SSE):

$$SSE = {\sum }_{k} {\vert {r}_{des} ( t ) ⊗ {r}_{ref} ( - t ) {\vert}_{t = kT} - b ( kT ) \vert}^{2} ,$$

where

b(t)=r_{ref}(t)\textcircled{×}r_{ref}(−t)

The SSE in the above equation is a summation of samples, which can be equivalently expressed in matrix notation (see Appendix A) as follows:

SSE(τ)=∥A′(τ)r−b₀(ρ)∥²

This SSE equation can be minimized with respect to the sample delay τ and the design pulse r, as expressed in the following minimization problem:

$${min}_{\underline{r}} {min}_{τ} SSE ( τ )$$

According to another aspect of the invention, the minimization problem above can be modified to take into account an ACLR requirement in the pulse optimization process. As explained above, ACLR is the ratio of power in an adjacent channel to the power in the transmitted channel. The maximum acceptable ACLR is dependent on the communications standard being used and/or on a particular design requirement. The adjacent and transmitted powers can be measured through the pulse-shaping filter. It can be shown that for zero-mean uncorrelated symbols that the ACLR is a function of only the reference pulse-shaping filter r_{ref} and the design pulse r_{des}. The in-channel component can be expressed as:

in-channel component=∫|r_{des}(t)\textcircled{×}r_{ref}(−t)|²dt

The out-of-channel component is obtained similarly but using a frequency-shifted matched filter:

off-channel component (i)=∫|r_{des}(t)\textcircled{×}r_{ref}(−t)e^{j2πf}^{ᵢ}^{t}|²dt,

where fᵢ is the frequency offset of the i'th adjacent channel.

Design of the optimized pulse-shaping filter having the prescribed ACLR is more accurate if minimization of ACLRs at multiple channels is performed. This can be accomplished by minimizing the weighted sum of ACLRs. For channels having more stringent ACLR requirements, a correspondingly larger weighted sum can be applied, as follows:

$$\begin{matrix}{ACLR}_{tot} = {\sum }_{i} {w}_{i} {ACLR}_{i} \\ = {\sum }_{i} {w}_{i} \frac{off channel component ( i )}{on channel component}\end{matrix}$$

where wᵢ is the ACLR weighting factor for channel i. ACLRₜₒₜ can be equivalently expressed in matrix form (see Appendix B) as:

$${ACLR}_{tot} = \frac{{‖ \underline{\underline{B}} \underline{r} ‖}^{2}}{{‖ A \underline{\underline{r}} ‖}^{2}}$$

Combining the two constraints discussed above, i.e., minimizing SSE while maintaining a predetermined ACLR requirement, an optimized pulse rₒₚₜ(t) can be determined by solving the following minimization problem:

$${min}_{\underline{r}} {min}_{τ} SSE ( τ ) subject to ( s . t . ) {ACLR}_{tot} = {α}^{2}$$

The problem can be solved by minimizing SSE:

$${min}_{\underline{r}} SSE ( τ ) ( s . t . ) {ACLR}_{tot} = {α}^{2}$$

for each τ and then selecting the τ for which the minimization is smallest.

So that the optimized filter can be implemented in hardware, the finite length of the desired filter is now factored into the optimization. Minimization is performed across pulses of length m. For example, r(t) is restricted to:

r(t)εR^{m}

where m is a nonnegative integer representing the length of the optimized filter and R^{m} represents vectors of numbers of size m. m can be chosen based on the particular hardware design requirements and/or used to lower the cost of the design by potentially reducing the number of chips and complexity needed to implement the filter in hardware. Since r(t) is restricted to be a real vector, it can written simply as r. This minimization equation can therefore be expressed using matrix notation as follows:

$${min}_{\underline{r}} {‖ {A}^{′} \underline{r} - {\underline{b}}_{0} ‖}^{2} s . t . \frac{{‖ {B}_{\underline{\_}} \underline{r} ‖}^{2}}{{‖ A \underline{r} ‖}^{2}} = {α}^{2}$$

The minimization problem can be further simplified to a least squares minimization with a quadratic inequality constraint (LSQI) problem by dropping the denominator ∥Ar∥², which is just a scaling factor. The solution to the LSQI problem

$${min}_{\underline{r}} ‖ {A}^{′} \underline{r} - {\underline{b}}_{0} ‖ s . t . ‖ {B}_{\underline{\_}} \underline{r} ‖ = {α}^{2}$$

can be found in standard matrix computation textbooks, as will be understood and appreciated by those of ordinary skill in the art.

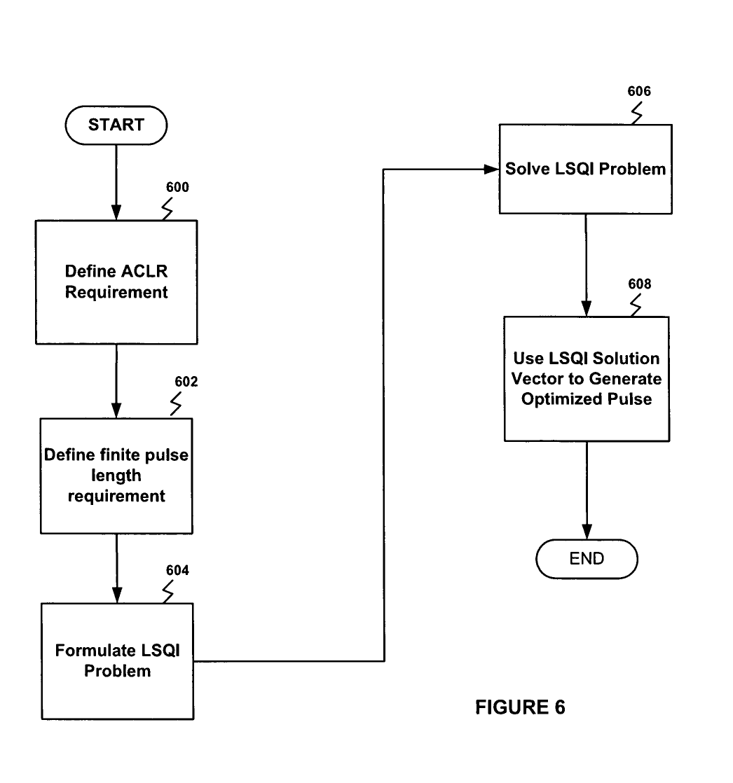

FIG. 6 is a flow chart summarizing salient steps in the pulse optimization algorithm described above. In a first step 600, an ACLR requirement is determined, from which a predetermined ACLR is set to satisfy an ACLR specification (e.g., as directed by a wireless communication standard or as required by a particular design application). Next, at step 602, the finite pulse length requirement is determined. At step 604, an in-channel minimization problem (e.g., an LSQI problem) is formulated subject to the predetermined ACLR. Next, at step 606 the minimization problem is presented to a minimization problem solver, which solves the minimization problem. The minimization problem solver can be implemented in various ways, including but not limited to hardware, firmware, software, and/or as an external dedicated apparatus. Finally, at step 608 results generated by the minimization problem solver are used to generate the desired design (i.e., optimized) pulse rₒₚₜ(t).

The following is a particular design example of a pulse-shaping filter for a UMTS transmitter using the pulse optimizing algorithm described above. According to this exemplary embodiment, it is assumed that the ‘ideal’ pulse-shaping filter comprises an RRC filter having a β=0.22 roll-off factor. Ideally, the time impulse response of the filter is infinite. However, in order to make hardware implementation of the design filter practicable, a finite length reference pulse-shaping filter is defined that has sufficient length to properly mimic the ideal filter, e.g., a length long enough so that the measured signal quality of the reference pulse-shaping filter is comparable to the predicted signal quality of ideal RRC filter. According to one aspect of the invention, the ideal RRC filter is multiplied by a Hanning window having a time span of 256 chips to obtain the desired pulse-shaping reference filter.

According to the pulse optimizing algorithm discussed above, the finite length design pulse is a pulse that yields minimum RMS EVM from among all pulses of the same length having a specified ACLR. According to this design example, a design pulse with time duration of 8 chips is used to approximate the RRC pulse. With 15 samples per chip, a total of 121 (8*15+1) samples are used to represent the design pulse. The reference filter uses 3841 (256*15+1) samples to represent the time impulse response.

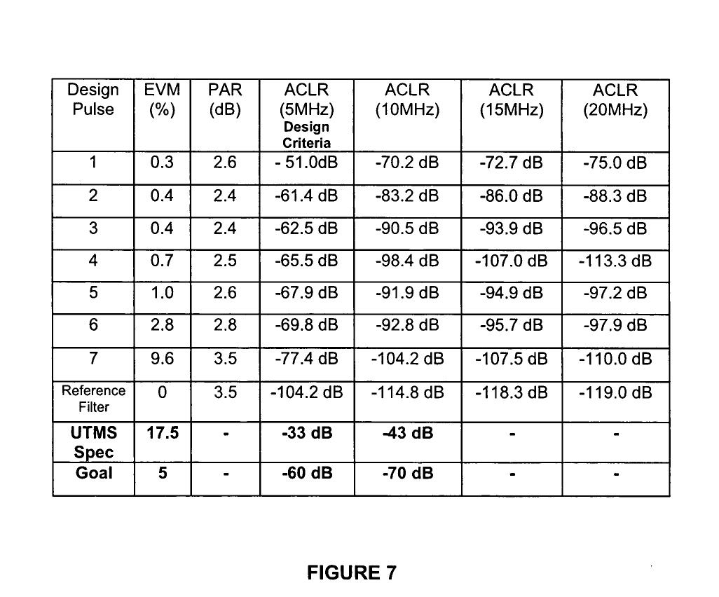

FIG. 7 is a table showing the EVM and ACLR performance characteristics of various design pulses obtained according to the design process. The in-band performance measures shown in the table include the EVM and PAR. The out-of-band performance measures shown in the table include the ACLR at 5 MHz, 10 MHz, 15 MHz, and 20 MHz away from the desired channel. According to one design example, each channel following the desired channel is required to have an ACLR that is 10 dB lower than the channel immediately preceding it. Given this ACLR requirement, the pulse optimization method above yields a design pulse having the lowest EVM. For example, consider design pulse 1 in the table in FIG. 7. The nearest adjacent channel (5 MHz) of this particular design pulse has an ACLR of −51 dB, and the higher adjacent channels have an ACLR greater than −70 dB. As shown in the table, the pulse optimization process provides a design pulse having an EVM of 0.3%. If ACLR is more stringent, e.g., less than −77.4 dB, then design pulse 7 could be used instead, although with the trade-off of having a higher EVM of 9.6%.

In this particular design example, the goal is to have a nearest channel ACLR that is approximately −50 dB. Including a 10 dB design margin to account for hardware impairment, the ACLR is then −60 dB, and −70 dB for the next highest adjacent channel. Design pulse 4 meets this criterion by achieving 0.71% EVM and −65.5 dB ACLR.

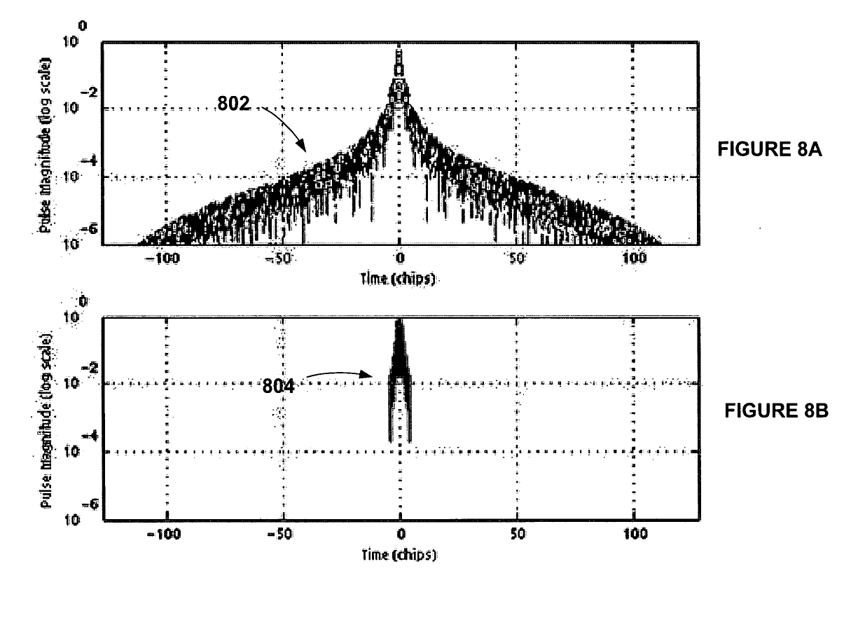

FIGS. 8A and 8B show the time impulse responses of the reference pulse and design pulse 4, respectively. Specifically, the top plot 802 in FIG. 8A shows the reference pulse magnitude on a log scale plotted against the time (measured by chips). The lower plot 804 in FIG. 8B shows the optimized design pulse magnitude plotted along the same time scale. As can be seen, the design pulse is significantly shorter in duration compared to the reference pulse, while preserving many of the spectral properties of the reference filter. The fewer number of chips needed to implement the design pulse results in a reduction in implementation complexity of the hardware.

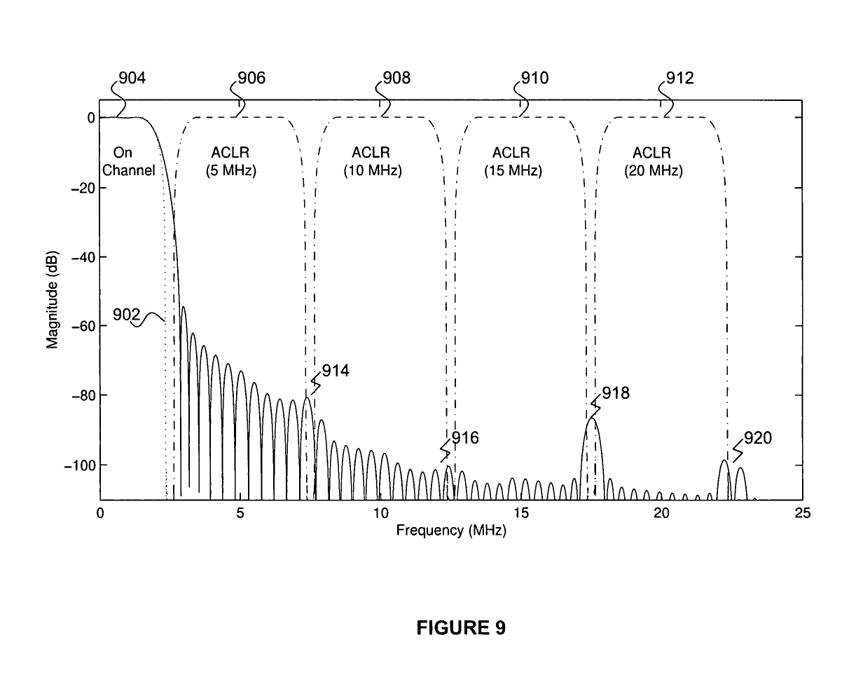

FIG. 9 is a plot of the power spectral density (PSD) of both the reference filter and the design filter 4 on the same axes with frequency plotted on the horizontal axis and magnitude on the vertical axis. Dotted line 902 represents the PSD of the reference filter at either the transmission or receiving side of the communications system. It has high magnitude in the on-channel region and rolls-off quickly into the adjacent channels. Solid line 904 represents the PSD of the design pulse for the transmission filter. The other four alternating dash-dotted lines 906-912 represent the receiver filters for the off-channels, which have a frequency separation of 5, 10, 15, and 20 MHz from the desired channel. In this example, the same filter is used in all of these off-channel receiving filters, but it in an alternative embodiment of the invention, other filters could be used.

As can be seen in the PSD plot in FIG. 9, the design filter has a slower roll-off in the frequency domain when compared to the reference filter, which spans the plot. As previously noted, this results in a finite length filter in the time domain. The slow PSD roll-off in the design filter takes place in between channels and has very little effect on the ACLR. This is because the receiver filter will greatly reject the energy that is not within its filter bandwidth. The general PSD distribution agrees with the measurements given in FIG. 7, i.e., the first and second ACLR are approximately −65.5 dB and −98.4 dB, respectively. Further, the pulse energy has been placed at local maxima 914-920, i.e., between adjacent channels, thereby improving EVM accuracy while maintaining good ACLR performance.

Another important parameter for filter design for hardware implementation is the Peak power to Average power Ratio (PAR). Lower PAR is desired, since it allows a power amplifier to operate further into the saturation region, where it is most efficient. An important example of where utilizing this efficiency is especially important is in mobile radio communications where battery life is a critical design factor.

In ideal UMTS signaling for the reverse link, one pilot channel with one data channel usually has a PAR of approximately 3.5 dB. This can be seen in FIG. 7 with the PAR of the reference filter. However, FIG. 7 shows that design pulse 4 has a PAR of 2.5 dB, which is a 1 dB improvement over the reference filter. The reduction in PAR of the design filter results from the fast roll-off in time impulse response, and allows an implemented system to achieve higher amplifier efficiency.

The accuracy and signal quality characteristics of the pulse generated from the optimization methods above can be further improved by making modifications to the ACLR constraint, depending on the current application. As previously discussed the off-channel component of the ACLR constraint can be expressed by the formula:

off-channel component (i)=∫|r_{des}(t)\textcircled{×}r_{ref}(−t)e^{j2πf}^{ᵢ}^{t}|²dt

In an alternative embodiment, the higher frequency off-channel receiver filters (say 10, 15 or 20 MHz away from the desired channel) are not the same as the on-channel receiver filter. According to this alternative embodiment, the off-channel receiver filters comprise rectangular or other types of filters. If the rectangular filters are used as the higher frequency off-channel receiver filters, the energy allocated at high frequency guard-bands can be suppressed significantly. As discussed in the design example above, the same receiver filter (RRC) is used for all channels. Accordingly, as can be seen in the plot shown in FIG. 9, there is relatively high-energy concentration compared to the adjacent frequencies at the guard-band between 15 and 20 MHz channels. This is because the PSD of the off-channel receiver filter is zero at the guard band. As a result, there is no penalty by placing energy on the guard-band. On the contrary, it helps to improve the EVM performance. However, the energy in the guard-band is relatively low compared to the on channel energy and improves upon the requirements given by the UMTS specification by a large margin. Nevertheless, if a required specification is more stringent and demands lower energy concentration at the guard-bands, the higher frequency off-channel RRC receiver filters can be replaced with other filter types, e.g., rectangular filters. The rectangular filter, which in zero at the guard-band and occupies the whole 5 MHz bandwidth, will suppress the energy emerged at the guard-band.

Another way of reducing the energy concentration at the guard-band can be achieved by reducing the channel spacing between adjacent channels. With this modification, the off-channel receiver filters will overlap in frequency. The PSD overlap for the off-channel receiver filters will suppress the energy concentration in the guard-bands because the weighting at the guard-band is non zero.

### Appendix A: Minimizing EVM Using Matrix Notation

For implementation purposes, the waveform is represented in terms of an over-sampled implementation.

Let r_{ref}(.) has support [−L,L] (2L+1 over-samples to represent the pulse) and peaks at t=0.
Let r_{des}(.) has support [−N,N] (2N+1 over-samples to represent the pulse), and N≦L.

### Then:

$$b ( t ) = {\sum }_{n} {r}_{ref} ( n ) {r}_{ref} ( n - t ) for t ∈ [ - 2 L , 2 L ]$$

$${r}_{des} ( t ) ⊗ {r}_{ref} ( t ) = {\sum }_{n} {r}_{des} ( n ) {r}_{ref} ( n - t ) for$$

$$t ∈ [ - ( L + N ) , ( L + N ) ]$$

### Let

\tilde{r}(t)=r_{des}(t)\textcircled{×}r_{ref}(t)

Then a matrix multiply can be used:

\tilde{r}=Ar

where

\tilde{r}≡[\tilde{r}(−(L+N))\tilde{r}(−(L+N)+1) . . . \tilde{r}(L+N)]^{T}

r≡[r(−N)r(−N+1) . . . r(N)]^{T}

and

$$A = [ \begin{matrix}{r}_{ref} ( + L ) & & 0 & 0 & ⋯ & & 0 \\ {r}_{ref} ( L - 1 ) & & {r}_{ref} ( + L ) & 0 & ⋯ & & 0 \\ {r}_{ref} ( L - 2 ) & & {r}_{ref} ( L - 1 ) & {r}_{ref} ( L ) & 0 & ⋯ & 0 \\ ⋮ & & & & & & 0 \\ ⋮ & & ⋰ & & & & {r}_{ref} ( L ) \\ {r}_{ref} ( - L ) & & & & & ⋮ & \\ 0 & & ⋰ & & & & \\ ⋮ & & & & & & \\ 0 & ⋯ & ⋯ & & 0 & & {r}_{ref} ( - L )\end{matrix} ]$$

Matrix A is a (2(L+N)+1)×(2N+1) Toeplitz matrix. Similarly, matrix multiplication can be used to express b(t):

b=Br_{ref}

where

b=[b(−2L)b(−2L+1) . . . b(2L)]^{T}

r_{ref}=[r_{ref}(−L)r_{ref}(−L+1) . . . p(L)]^{T}

and

$$B = [ \begin{matrix}{r}_{ref} ( + L ) & 0 & ⋯ & 0 \\ ⋮ & & & ⋮ \\ ⋮ & & & {r}_{ref} ( L ) \\ {r}_{ref} ( - L ) & & & ⋮ \\ 0 & ⋰ & & ⋮ \\ 0 & ⋯ & & {r}_{ref} ( - L )\end{matrix} ]$$

In order to obtain the SSE, some manipulation of the equation is required. First, define

$$\underline{{\tilde{r}}^{′}} ( τ ) = [ \begin{matrix}\tilde{r} ( - ( L + N ) + τ ) \\ \tilde{r} ( - ( L + N ) + τ + {N}_{T} ) \\ ⋮ \\ \tilde{r} ( - ( L + N ) + τ + ( {N}_{τ} - 1 ) {N}_{T} )\end{matrix} ]$$

where

−(L+N)+τ+(N_{τ}−1)N_{T}≦L+N

τ is a delay factor and it has a range of 0≦τ<N_{T}, N_{T} is the number of over-samples per symbol, and N_{τ} is the largest integer close to but smaller than (2(L+N)−τ)/N_{T}+1. The output of the matched filter is sampled at every T second to measure the EVM. As a result, to define the SSE, only the samples that are separated by integer multiple of N_{T} are considered. Therefore:

\tilde{r}′(τ)=A′(τ)r

where A′(τ) can be expressed as:

$${A}^{′} ( τ ) = [ \begin{matrix}{r}_{ref} ( L - τ ) & & {r}_{ref} ( L - τ + 1 ) & ⋯ & {r}_{ref} ( L ) & 0 & ⋯ & 0 \\ {r}_{ref} ( L - τ - {N}_{T} ) & & {r}_{ref} ( L - τ - {N}_{T} + 1 ) & ⋯ & {r}_{ref} ( L ) & 0 & ⋯ & 0 \\ {r}_{ref} ( L - τ - 2 {N}_{T} ) & & {r}_{ref} ( L - τ - 2 {N}_{T} + 1 ) & ⋯ & {r}_{ref} ( L ) & 0 & ⋯ & 0 \\ ⋮ & ⋰ & & & & ⋮ & & \\ ⋮ & & ⋯ & & & & & \begin{matrix}{r}_{ref} ( L + 2 N - τ - \\ ( N τ - 1 ) {N}_{T} )\end{matrix}\end{matrix} ]$$

A similar approach can be used to define the sampled output of the ideal signal.

$${b}^{′} ( τ ) = [ \begin{matrix}⋮ \\ b ( - ( L + N ) + τ - {N}_{T} ) \\ ⋯ \\ b ( - ( L + N ) + τ ) \\ b ( - ( L + N ) + τ + {N}_{T} ) \\ ⋮ \\ b ( - ( L + N ) + τ + ( {N}_{τ} - 1 ) {N}_{T} ) \\ ⋯ \\ b ( L + N + τ + {N}_{τ} {N}_{T} ) \\ ⋮\end{matrix} ] = [ \begin{matrix}{\underline{b}}_{-} ( τ ) \\ ⋯ \\ {\underline{b}}_{0} ( τ ) \\ ⋯ \\ {\underline{b}}_{+} ( τ )\end{matrix} ]$$

The equation for the SSE can then be written as:

SSE(τ)=∥\tilde{r}′(τ)−b₀(τ)∥²+∥b₋(τ)∥²+∥b₊(τ)∥²

The last two terms can be dropped from the SSE optimization. As a result, the cost function reduces to:

SSE(τ)=∥\tilde{r}′(τ)−b₀(τ)∥²

Then

SSE(τ)=μA′(τ)r−b₀(τ)∥²

Finally, the following equation can be minimized to reduce RMS EVM:

$${min}_{\underline{x}} {min}_{τ} SSE ( τ )$$

### Appendix B: Representing ACLR Using Matrix Notation

ACLR is the ratio of power in a nearby channel to the power in the transmitted channel. These powers are measured through the reference pulse-shaping filter r_{ref}(.). It can be shown that for zero-mean uncorrelated symbols that ACLR is a function of only r_{ref}(.) and the transmitted pulse r_{des}() As derived in Appendix A, the on-channel component is given by

$${\sum }_{t} {\vert {r}_{des} ( t ) ⊗ {r}_{ref} ( - t ) \vert}^{2} = {\sum }_{t} {\vert \tilde{r} ( t ) \vert}^{2} = {‖ \underline{\tilde{r}} ‖}^{2} = {‖ A \underline{r} ‖}^{2}$$

The off-channel component is obtained similarly but using a frequency-shifted matched-filter.

Let f₁ be the frequency offset of the i th adjacent channel. Then the corresponding off-channel component is expressed as:

$$\begin{matrix}{\sum }_{t} \text{\textbar} {r}_{des} ( t ) ⊗ ( {r}_{ref} ( - t ) {e}^{j 2 π {f}_{i} t} ) {\text{\textbar}}^{2} = {\sum }_{t} \vert {\sum }_{n} {r}_{des} ( n ) {r}_{ref} \\ { ( n - t ) {e}^{j 2 π {f}_{i} ( t - n )} \vert}^{2} \\ = {‖ {B}_{i} \underline{r} ‖}^{2}\end{matrix}$$

Where Bᵢ is a Toeplitz matrix and:

$${B}_{i} = [ \begin{matrix}{r}_{ref} ( L ) {e}^{j 2 π {f}_{i} ( - L )} & & & 0 & ⋯ & 0 \\ {r}_{ref} ( L - 1 ) {e}^{j 2 π {f}_{i} ( - L + 1 )} & & & {r}_{ref} ( L ) {e}^{j 2 π {f}_{i} ( - L )} & & ⋮ \\ ⋮ & & ⋰ & & & 0 \\ ⋮ & & & & & {r}_{ref} ( L ) {e}^{j 2 π {f}_{i} ( - L )} \\ {r}_{ref} ( - L ) {e}^{j 2 π {f}_{i} ( L )} & & & ⋮ & & ⋮ \\ 0 & ⋰ & ⋮ & & & \\ 0 & ⋯ & & & 0 & {r}_{ref} ( - L ) {e}^{j 2 π {f}_{i} ( L )}\end{matrix} ]$$

The ACLRs at multiple channels have to be simultaneously minimized. For this purpose, the weighted sum of ACLRs minimized. For channels that have more stringent ACLR requirements, a correspondingly larger weighting may be applied.

$${ACLR}_{tot} = {\sum }_{i} {w}_{i} {ACLR}_{i} = {\sum }_{i} {w}_{i} \frac{{‖ {B}_{i} \underline{r} ‖}^{2}}{{‖ A \underline{r} ‖}^{2}} = \frac{{‖ {B}_{\underline{\_}} \underline{r} ‖}^{2}}{{‖ A \underline{r} ‖}^{2}}$$

$$where$$

$${B}_{\underline{\_}} = [ \begin{matrix}\sqrt{{w}_{1}} {B}_{1} \\ \sqrt{{w}_{2}} {B}_{2} \\ ⋮\end{matrix} ]$$

While the above is a complete description of the preferred embodiments of the invention sufficiently detailed to enable those skilled in the art to build and implement the system, it should be understood that various changes, substitutions, and alterations may be made without departing from the spirit and scope of the invention as defined by the appended claims.

What is claimed:

1. A communications transmitter, comprising:
a modulator configured to receive a sequence of binary bits and generate symbols represented by a plurality of impulses; and
a finite length pulse-shaping filter configured to receive said plurality of impulses and generate a continuous waveform,
wherein said finite length pulse-shaping filter is configured to condition said plurality of impulses to minimize the degree by which said pulse-shaping filter contributes to in-channel distortion of said continuous waveform.

2. The communications transmitter of claim 1 wherein the finite length filter is further configured to condition the plurality of impulses by reducing the time duration of its impulse response.

3. The communications transmitter of claim 2 wherein reducing the time duration of the finite length filter's impulse response is determined subject to a hardware criterion.

4. The communications transmitter of claim 1 wherein said finite length pulse-shaping filter is configured to approximate a filter having an infinite time impulse response.

5. The communications transmitter of claim 1 wherein said finite length pulse-shaping filter is further configured to condition said impulses so that said continuous waveform satisfies a predetermined adjacent channel power criterion.

6. A method of optimizing a pulse-shaping filter, comprising:
defining a reference pulse-shaping filter; and
using characteristics of said reference pulse-shaping filter, performing an optimization process that computes an optimized pulse for use by an optimized pulse-shaping filter,
wherein computing said optimized pulse is performed so that when said optimized pulse-shaping filter is used to pulse-shape an input signal, the optimized pulse-shaping filter operates to minimize introduction of in-channel distortion into the resulting pulse-shaped signal.

7. The method of claim 6 wherein computing said optimized pulse is performed subject to a predetermined out-of-channel signal quality criterion.

8. The method of claim 6 wherein computing said optimized pulse comprises solving a minimization problem characterized by the degree by which said pulse contributes to the in channel distortion of said continuous waveform.

9. The method of claim 6 wherein computing said optimized pulse further comprises selecting from a function from among a space of finite length functions.

10. The method of claim 6 wherein computing said optimized pulse is performed in a manner that depends on predetermined hardware characteristics of the optimized pulse-shaping filter.

11. The method of claim 6 wherein said optimized pulse-shaping filter is operable to provide the optimized pulse in a manner that approximates a pulse provided by the reference pulse-shaping filter.

12. The method of claim 11 wherein said reference pulse-shaping filter is modeled after a more ideal pulse-shaping filter that provides a more ideal pulse-shaped pulse.

13. The method of claim 12 wherein said more ideal pulse-shaping filter has an essentially infinite time impulse response.

14. The method of claim 13 wherein said more ideal pulse-shaping filter comprises a root-raised cosine (RRC) pulse-shaping filter.

15. The method of claim 6 wherein computing said optimized pulse is performed in a manner that reduces the peak-to-average ratio (PAR) of said input signal.

16. A method of optimizing the pulse-shaping capability of a pulse-shaping filter, comprising:
providing a finite length pulse-shaping filter that approximates a more ideal pulse-shaping filter;
specifying at least one optimization criterion for said finite length pulse-shaping filter, said at least one optimization criterion characterized by an in-channel signal quality; and
generating a pulse-shaped signal using said finite length pulse-shaping filter.

17. The method of claim 16 wherein said at least one optimization criterion further includes a desired length of said finite length pulse-shaping filter.

18. The method of claim 17, further comprising changing the desired length of said finite length pulse-shaping filter if the finite length pulse-shaping filter does not satisfy an in-channel distortion criterion.

19. The method of claim 16 wherein said at least one optimization criterion is further characterized by an out-of-channel distortion criterion.

20. The method of claim 16 wherein said more ideal pulse-shaping filter is modeled after a filter having an essentially infinite time impulse response.

21. The method of claim 16 wherein said more ideal pulse-shaping filter is modeled after a root-raised cosine (RRC) pulse-shaping filter.

22. The method of claim 16 wherein generating a pulse-shaped signal using said finite length pulse-shaping filter results in a modified signal having a reduced peak-to-average ratio (PAR).

23. The method of claim 16 wherein specifying at least one optimization criterion for said finite length pulse-shaping filter comprises specifying at least on optimization criterion that ensures that the finite length pulse-shaping filter generates a pulse-shaped signal that satisfies a communications standard.

24. The method of claim 23 wherein the communications standard comprises a standard specifying ate least one distortion specification for operating in a UMTS communications system.
